(19) United States
(12) Patent Application Publication
(10) Pub. No.: US 2010/0144390 A1
(43) Pub. Date: Jun. 10, 2010

(54) DIALING DEVICE FOR MOBILE PHONE AND METHOD FOR USING THE SAME

(75) Inventor: I-CHIEN CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/494,462

(22) Filed: Jun. 30, 2009

(30) Foreign Application Priority Data
Dec. 5, 2008 (CN) 200810306005.1

(51) Int. Cl. H04B 1/38

(52) U.S. Cl. 455/564

(57) ABSTRACT

A dialing device of a mobile phone includes a communicating unit for wireless communication, a processor unit electronically connected to the communicating unit for storing phone numbers, and a recording unit electronically connected to the communicating unit for recording and storing audio signals. The processor unit automatically dials predetermined phone numbers through the communicating unit, and the recording unit automatically sends stored audio signals corresponding to the dialed phone number to the receiver through the communicating unit when the dialed phone number answers.

### BACKGROUND

1. Technical Field

The present disclosure relates to dialing devices for mobile phones and dialing methods, and particularly to a dialing device for a mobile phone for automatic communication and a method for using the same.

2. Description of Related Art

Mobile phones may be provided with the function of automatic dialing. In use, a mobile phone can automatically dial phone numbers at predetermined times, and thus the user need not manually dial the phone numbers.

However, although the mobile phone automatically dials phone numbers, the user still needs to speak into the receiver. If the user does not at the moment have their mobile phone in hand or are otherwise disposed when a call is automatically dialed, the user cannot immediately speak into the receiver, then the call is wasted and the dialed party is disturbed.

Furthermore, when conventional mobile phones automatically dial at predetermined times, they generally do not detect their communication status. If a mobile phone is not currently connected to a communication network, the automatic dialing operation will still occur and waste battery power of the mobile phone.

Therefore, there is room for improvement within the art.

### BRIEF DESCRIPTION OF THE DRAWINGS

Many aspects of the present dialing device and method for using the same can be better understood with reference to the following drawings. The components in the various drawings are not necessarily drawn to scale, the emphasis instead being placed upon clearly illustrating the principles of the present dialing device and method fro using the same. Moreover, in the drawings, like reference numerals designate corresponding parts throughout the figures.

FIG. 1 is a block diagram of a dialing device used in a mobile phone, according to an exemplary embodiment.

FIG. 3 is a flow chart of a dialing method, according to an exemplary embodiment.

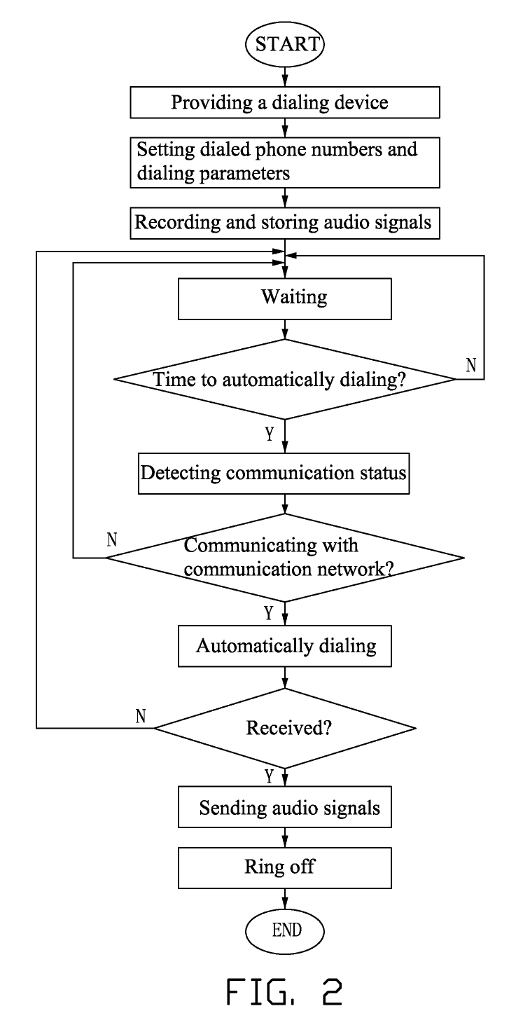

### DETAILED DESCRIPTION

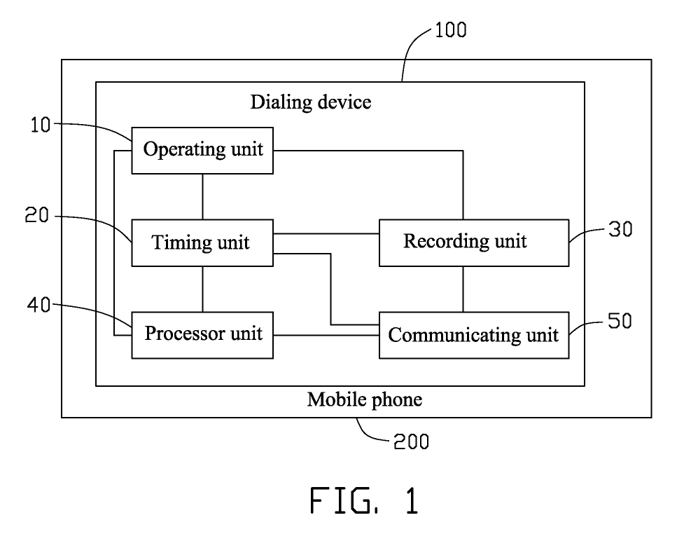

Referring to FIG. 1, a dialing device 100 according to an exemplary embodiment is provided. The dialing device 100 is used in a mobile phone 200 to automatically place phone calls The dialing device 100 includes an operating unit 10, a timing unit 20, a recording unit 30, a processor unit 40 and a communicating unit 50.

The operating unit 10 can be a conventional operating device of the mobile phone 200, such as a keypad and display. The operating unit 10 is used to operate the dialing device 100. The timing unit 20 is a timer electronically connected to the operating unit 10 for setting the time to automatically place a call. The recording unit 30 is a conventional recording chip electronically connected to the operating unit 10 and the timing unit 20. The recording unit 30 is used to record, store and play audio signals. The processor unit 40 is a data processor such as a CPU or a single chip electronically connected to the operating unit 10 and the timing unit 20. The processor unit 40 can store phone numbers and automatically dial the stored phone number upon receiving a request signal. The communicating unit 50 can be conventional communicating components of the mobile phone 200, such as RF circuits and antennas. The communicating unit 50 is electronically connected to the timing unit 20, the recording unit 30 and the processor unit 40. The communicating unit 50 is used for wirelessly communicating over a network. Further, the communicating unit 50 can also detect if the mobile phone 200 can successfully communicate with communication networks according to instruction of the processor unit 40.

Also referring to FIG. 2, a method for automatically placing calls through a dialing device (e.g., the dialing device 100) of a mobile phone (e.g., the mobile phone 200) for wireless communication, according to an exemplary embodiment, is provided. The method includes these steps as follows.

First, the dialing device 100 is provided and installed in the mobile phone 200.

The mobile phone 200 is operated through the operating unit 10. The phone numbers to be automatically dialed are set and stored in the processor unit 40. The audio files corresponding to the phone numbers and that are to be automatically sent to the phone numbers are recorded and stored by the recording unit 30. Understandably, different audio files corresponding to different phone numbers can be respectively stored. Some dialing parameters, such as when to commence an automatic dialing procedure, how often and how many times to re-dial when placing call is unsuccessful, can also be set and stored in the processor unit 40 through the operating unit 10.

After setting and storing parameters, the timing unit 20 starts to track time. Before the first predetermined automatic dialing time arrives, the mobile phone 200 enters a conventional standby status. The mobile phone 200 can be used to manually dial phone numbers and receive calls. When the first predetermined automatic dialing time arrives, the timing unit 20 sends a request signal to the communicating unit 50.

When receiving the request signal, the communicating unit 50 detects if the mobile phone 200 can successfully communicate with at least one communication network (e.g., GSM, CDMA, etc.) through wireless signals.

If the mobile phone 200 is not able to successfully communicate with any communication network, the communicating unit 50 sends a response signal to the timing unit 20. Thus, the timing unit 20 continues to time and the mobile phone 200 remains in standby status. When a next predetermined automatic dialing time arrives, the timing unit 20 sends a new request signal to the communicating unit 50 to drive the communicating unit 50 to detect the communication status of the mobile phone 200 again. Otherwise, after sending the response signal, the communicating unit 50 can also continually or periodically detect the communication status of the mobile phone 200 according to the predetermined parameters until the mobile phone 200 communicates with at least one communication network, without waiting for the next automatic dialing time.

If the mobile phone 200 successfully communicates with any communication network, the communicating unit 50 sends a request signal to the processor unit 40. The processor unit 40 then automatically dials a predetermined phone number according to the request signal, and the communicating unit 50 calls the receiver corresponding to the phone number through the communication network.

If the call corresponding to the dialed phone member is not answered, the communicating unit 50 can automatically stop calling, and the mobile phone 200 resumes standby status. When the timing unit 20 indicates that a next automatic dialing time arrives, the steps of detecting communication status and dialing can be performed again. Otherwise, the processor unit 40 can periodically re-dial the phone number according to the predetermined parameters and does not wait for the next automatic dialing time.

When the call corresponding to the dialed phone member is answered, the communicating unit 50 sends a request signal to the recording unit 30, and the recording unit 30 automatically sends a stored audio file corresponding to the phone number to the receiver through the communicating unit 50. After sending the audio file, the processor unit 40 can automatically hang up thus saving battery power.

The present dialing device 100 can automatically dial phone numbers at predetermined times and send stored audio files to the phone numbers. In use, manual dialing and speaking operations can be omitted. In this way, the mobile phone 200 using the dialing device 100 need not be in the users possession or the user need not be immediately available to speak, when calls are automatically placed, and the receivers corresponding to the dialed phone numbers can listen to a message from the user. Therefore, the mobile phone 200 is much easier to use than typical mobile phones, and has many advantages. Furthermore, the present dialing method includes the step of detecting the communication status of the mobile phone 200 before automatically dialing. According to the detecting results, the dialing device 100 can be prevented from needless attempts at placing calls and wasting battery power when the mobile phone 200 cannot connect to a communication network.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A dialing device for a mobile phone, comprising:
a communicating unit for wireless communication;
a processor unit electronically connected to the communicating unit, the processor unit storing phone numbers; and
a recording unit electronically connected to the communicating unit, the recording unit recording and storing audio signals; wherein the processor unit automatically dials predetermined phone numbers through the communicating unit, and the recording unit automatically sends stored audio signals corresponding to the dialed phone number to the receiver through the communicating unit when the dialed phone number answers.

2. The dialing device as claimed in claim 1, further comprising a timing unit electronically connected to the processor unit for setting and timing when the dialing occurs.

3. The dialing device as claimed in claim 1, further comprising an operating unit electronically connected to the timing unit, the recording unit and the processor unit for operating the dialing device.

4. The dialing device as claimed in claim 1, wherein dialing parameters are stored in the processor unit.

5. The dialing device as claimed in claim 1, wherein the processor unit automatically dials stored phone numbers when the communicating unit sends a request signal to the processor unit.

6. The dialing device as claimed in claim 1, wherein the recording unit automatically sends stored audio signals to the receiver when the communicating unit sends a request signal to the recording unit.

7. A method for automatically dialing phone numbers through a dialing device of a mobile phone in a wireless communication comprising:
setting and storing phone numbers to be automatically dialed and the times for the numbers to be dialed;
recording and storing audio signals corresponding to the phone numbers and to be sent to the phone numbers;
dialing the predetermined phone numbers to call the phone numbers at their corresponding times; and
sending audio signals corresponding to the dialed phone numbers to the phone numbers when the call is answered.

8. The method as claimed in claim 7, further comprising a step of setting and storing dialing parameters.

9. The method as claimed in claim 8, further comprising a step of keeping the mobile phone in a standby status after the step of setting and storing dialing parameters.

10. The method as claimed in claim 9, further comprising a step of detecting the communication status of the mobile phone before dialing the predetermined phone numbers.

11. The method as claimed in claim 10, further comprising a step of keeping the mobile phone in the standby status and continuing to time until the next dialing time when the mobile phone does not successfully communicate with any communication network.

12. The method as claimed in claim 10, further comprising a step of continually detecting the communication status of the mobile phone in a predetermined frequency until the mobile phone communicates with at least one communication network when the mobile phone does not successfully communicate with any communication network.

13. The method as claimed in claim 10, further comprising a step of dialing the predetermined phone numbers when the mobile phone successfully communicates with any communication network.

14. The method as claimed in claim 13, further comprising a step of resuming the mobile phone to the standby status when the call is not answered.

15. The method as claimed in claim 13, further comprising a step of re-dialing the phone number in predetermined frequencies and times when the call is not received.
